(19) United States
(12) Patent Application Publication
(10) Pub. No.: US 2016/0138134 A1
(43) Pub. Date: May 19, 2016

(54) PALLADIUM-BASED ALLOY

(71) Applicant: OMEGA SA, Biel/Bienne (CH)

(72) Inventors: Gregory KISSLING, Macolin (CH); Denis VINCENT, Neuchatel (CH); Stephane LAUPER, Cortaillod (CH); Gaetan VILLARD, L'Abbaye (CH); Alban DUBACH, Bienne (CH)

(73) Assignee: OMEGA SA, Biel/Bienne (CH)

(21) Appl. No.: 14/922,264

(22) Filed: Oct. 26, 2015

(30) Foreign Application Priority Data
Nov. 17, 2014 (EP) 14193495.0

(51) Int. Cl. C22C 5/04; G04B 37/22; A44C 27/00

(52) U.S. Cl. CPC C22C 5/04; A44C 27/003; G04B 37/22

(57) ABSTRACT

A palladium-based alloy including, expressed in weight, between 50 and 55% of palladium, between 45% and 50% of rhodium; a quantity x of silver where 0%≦x≦5%, and a quantity R of a balance including at least one element selected from among iridium, ruthenium, platinum, titanium, zirconium and rhenium and combinations thereof, where 0%≦R≦5%. The invention also relates to a A timepiece or piece of jewellery including at least one component made of such an alloy.

This application claims priority from European Patent Application No. 14193495.0 filed on Nov. 17, 2014, the entire disclosure of which is hereby incorporated herein by reference.

### FIELD OF THE INVENTION

The invention relates to a palladium-based alloy. The invention also relates to a timepiece or piece of jewellery comprising at least one component made of such an alloy.

### BACKGROUND OF THE INVENTION

In the fields of horology and jewellery, three types of precious alloys are white: platinum alloys, palladium alloys and gold alloys. At present, most manufacturers of precious metal alloys for these fields have the same objective: to find a very white alloy, close to the colour of rhodium which is a reference in this field, exhibiting the following characteristics: solid, stamped with a hallmark, resistant to corrosion and particularly to tarnishing, easy to cast and deform, resistant to scratching (minimum 160 HV in the annealed state) and easy to machine, economical and conforming to European standard EN1811 on the release of nickel. This objective is difficult to achieve using known conventional techniques. 18 carat grey gold and silver alloys are mostly rhodium-plated, 950% platinum alloys are very white but very expensive, due to the high platinum content and the high cost of platinum. The palladium alloys known to date are too grey, not white enough, and pure rhodium, in the solid state, is difficult to cold work because it has a high melting point.

The Platinum Metals Review (2013, 57 (3), 202-213) describes the main colorimetric properties of the precious alloys presented in Table 1, according to the L*a*b colour model (CIE 1976).

TABLE 1
Colorimetric values of precious metal alloys, Platinum Metals
Review (2013, 57, (3), 202-213)

| | L | a* green-red | b* yellow-blue |
|---|---|---|---|
| Platinum alloys and | 85 | 0 | 4.5 |
| platinum group | | | |
| alloys | | | |
| Pure silver | 95 | −0.5 | 4.2 |
| 18 carat grey gold | 84 | 0 | 9.5 |
| 14 carat grey gold | 84 | −0.5 | 9 |

Various research has been carried out to propose very white alloys. Thus, patent publication WO 2010/127458 describes a grey gold alloy with no nickel and with no copper, which is gold-based, and comprises palladium and a certain number of alloying elements used to improve various properties of alloys. The alloys obtained advantageously have colorimetric values whose chromaticity (a*, b*) is slightly less than the binary gold-palladium 18 carat alloy, but remain grey (L>81).

Patent publication EP 2 546 371 describes a gold-based grey gold alloy comprising chromium and a certain number of alloying elements, used to improve various properties of the alloys. The alloys obtained have colorimetric values that are exceptional as regards chromaticity and interesting as regards the L value (>83). However, in both cases, the alloying elements employed are relatively reactive to the processes used in conventional jewellery making, particularly the use of a blow torch, producing oxides which affect the much desired brightness, indicated by the high L value.

Patent publication EP 2 420 583 opened up a new way forward in the world of very white precious metals. It describes, in particular, a solid, very white alloy formed of 50% by weight of platinum and 50% by weight of rhodium, which is very resistant to corrosion, close to the colour of rhodium using high temperature deformation techniques to prevent spinodal decomposition above 800° C. between the two elements, resulting in poor cold workability of the alloy due to the heterogeneity of the alloy. This technique therefore makes this alloy particularly attractive for the field of horology/jewellery except for two significant major drawbacks for the end consumer: the price of the alloy remains high due to the presence of platinum; and 500 platinum or 500 rhodium are not grades that are legally recognised by international and national organisations. A product with no hallmark is difficult for consumers to accept since a doubt remains as to the actual composition of the precious metals contained in the alloy. Apart from these two drawbacks, the alloy has a relatively high melting point (˜1900° C.) making it particularly difficult to cast for jewellery applications.

### SUMMARY OF THE INVENTION

It is an object of the invention to overcome the various drawbacks of known alloys.

More specifically, it is an object of the invention to provide very white alloys, which are close to the colour of rhodium, economical, can be hallmarked, and have a lower melting point (˜1750° C.), and a resistance to oxidation allowing the use of conventional jewellery making techniques.

It is also an object of the invention to provide nickel free precious metal alloys which thus advantageously comply with regulations on nickel release.

To this end, the present invention relates to a palladium-based alloy comprising, expressed in weight, between 50 and 55% of palladium, between 45% and 50% of rhodium; a quantity x of silver where 0%≦x≦5% and a quantity R of a balance comprising at least one element selected from among iridium, ruthenium, platinum, titanium, zirconium and rhenium and combinations thereof, where 0%≦R≦5%.

According to a variant embodiment, x is lower than or equal to 2%.

According to a preferred embodiment, the alloy may comprise, expressed in weight: between 50 and 53% of palladium, between 47% and 50% of rhodium; a quantity x of silver where 0%≦x≦2%, and a quantity R of a balance comprising at least one element selected from among iridium, ruthenium, platinum, titanium, zirconium and rhenium and combinations thereof, where 0%≦R≦3%.

According to another preferred variant embodiment, x is equal to 0.

According to a variant embodiment, R is lower than or equal to 1%, preferably lower than or equal to 0.5%, and more preferably lower than or equal to 0.1%. R can be equal to 0 or different from 0.

According to a preferred variant embodiment, R is equal to 0.

According to a preferred variant embodiment, x and R are equal to 0.

The alloys according to the invention are very white, can be hallmarked, and have suitable properties allowing for use in the fields of horology or jewellery.

The present invention also relates to a timepiece or a piece of jewellery including at least one component made of an alloy as defined above.

The present invention also relates to the use of an alloy as defined above in a timepiece or piece of jewellery.

### DETAILED DESCRIPTION OF PREFERRED EMBODIMENTS

The present invention relates to a palladium-based alloy comprising, expressed in weight, between 50 and 55% of palladium, between 45% and 50% of rhodium; a quantity x of silver where 0≦x≦5%, preferably 0%≦x≦4%, and more preferably 0%≦R≦1%, and a quantity R of a balance comprising at least one element selected from among iridium, ruthenium, platinum, titanium, zirconium and rhenium and combinations thereof, where 0%≦R≦5%, preferably 0%≦R≦3%, preferably 0%≦R≦1%, and more preferably 0%≦R≦0.1%.

The alloys obtained have, after polishing, colorimetric values according to the L*a*b* chromatic model (CIE 1976) such that L* is comprised between 84 and 91, a* is lower than or equal to 1 and b* is lower than or equal to 4.5. Preferably, L* is comprised between 88 and 90, a* is lower than or equal to 0.8 and b* is lower than or equal to 3.

The alloying elements, such as iridium, ruthenium, platinum, titanium, zirconium and rhenium could be optionally used to improve, for example, metallurgical properties, such as casting, to prevent porosity, or to improve the properties of the alloy such as deformation or brightness.

The alloys conforming to the aforementioned definition are precious metal alloys complying with all the criteria required for alloys intended to be used in the field of horology or jewellery, notably as regards their colour, brilliance, hallmark, reasonable price, improved castability, solid alloys with good corrosion resistance, nickel free, scratch resistant (minimum 160 HV in the annealed state) and easy to machine.

According to a first embodiment, the alloy comprises a quantity of silver x lower than or equal to 2%.

According to a first variant, the palladium alloy comprises, expressed in weight: from 50 to 53% of palladium, from 47 to 50% of rhodium, from 0 to 2% of silver, the balance comprising at least one of the elements Ir, Ru, Pt, Ti, Zr and Re.

According to another variant, the palladium alloy comprises, expressed in weight, from 50 to 55% of palladium, from 45% to 50% of rhodium, and from 0 to 2% of silver, the quantity R of alloying elements (balance) being preferably equal to 0.

According to a second embodiment, x is equal to 0 so that the alloy of the invention does not contain silver. The palladium alloy can then comprise, expressed in weight, from 50 to 55% of palladium, from 45 to 50% of rhodium, the balance comprising at least one of the elements Ir, Ru, Pt, Ti, Zr and Re, for a total value of the balance as defined above, and preferably lower than 0.1.

According to another embodiment, x is different from 0 so that the alloy of the invention contains silver. The palladium-based alloy can then comprise, expressed in weight, between 50 and 55% of palladium, between 45% and 50% of rhodium; a quantity x of silver where 0%≦x≦5%, and a quantity R of a balance comprising at least one element selected from among iridium, ruthenium, platinum, titanium, zirconium and rhenium and combinations thereof, where 0%≦R≦5%, preferably 0%≦R≦3%, preferably 0%≦R≦1%, and more preferably 0%≦R≦0.1%. The quantity of silver may then be such that 0.1%≦x≦5%, preferably such that 0.1%≦x≦4%, and more preferably 0.1%≦x≦2%.

According to another embodiment, x and R are equal to 0 such that the alloy of the invention contains neither silver nor alloying elements (balance) as defined in the balance above. In such case, the palladium alloy comprises, expressed in weight, from 50% to 55% of palladium, and from 45% to 50% of rhodium.

According to a preferred embodiment, the palladium-based alloy is a 500 palladium alloy and contains, expressed in weight, 50% of palladium, a minimum of 49% of rhodium, the balance comprising at least one of the elements Ir, Ru, Pt, Ti, Zr.

According to another preferred embodiment, the palladium alloy is a 500 palladium alloy and contains, expressed in weight, 50% of palladium, 45% of rhodium, and a maximum of 4% of silver, the balance comprising at least one of the elements Ir, Ru, Pt, Ti, Zr.

According to another preferred embodiment, the palladium alloy is a 500 palladium alloy and contains, expressed in weight, 50% of palladium, 45% of rhodium, and 5% of silver.

According to another preferred embodiment, the palladium alloy contains, expressed in weight, 50% of palladium and 50% of rhodium.

To prepare the palladium alloy according to the invention, the procedure is as follows:

The main elements involved in the composition of the alloy have a purity of at least 999% and are deoxidised. The elements of the alloy composition are placed in a crucible and heated until the elements melt. The heating is performed in a sealed induction furnace under a nitrogen partial pressure. The melted alloy is then poured into an ingot mould. After solidifying, the ingot is water hardened. The hardened ingot is then hot worked at 1000° C. then annealed. The rate of strain hardening between each annealing is from 60 to 80%. Each annealing lasts between 20 to 30 minutes and occurs at 1000° C. in a reducing atmosphere constituted of N₂ and H₂. Cooling between each annealing is accomplished by water quenching.

The following examples illustrate the present invention without thereby limiting its scope.

Table 2 below indicates the composition of the various “very white” materials tested. The proportions indicated are expressed in weight percentage. Comparative example 1 is an alloy constituted of 95% platinum and 5% ruthenium. This alloy is the reference for the colour level of platinum alloys in the world of jewellery. Comparative example 2 relates to the alloy constituted of 50% platinum and 50% rhodium described in Patent publication EP 2 420 583. Comparative example 3 is pure rhodium.

Two examples according to the invention (examples 4 and 5) were produced, namely an alloy constituted of 50% palladium and 50% rhodium and an alloy constituted of 50% palladium, 45% rhodium and 5% silver.

TABLE 2

| Example | Material |
|---|---|
| 1 (comp.) | Pt95Ru |
| 2 (comp.) | Pt50Rh50 |
| 3 (comp.) | Pure Rh |
| 4 (inv.) | Pd50Rh50 |
| 5 (inv.) | Pd50Rh45Ag5 |

The colorimetric values of these materials is measured using the L*a*b* chromatic model (CIE 1976) (measured after polishing, the samples having been polished to 1 micron level), in addition to the density, Vickers hardness in the annealed state and the melting point.

The colorimetric values are measured with a MINOLTA CM 3610 d apparatus in the following conditions:
Illuminant: D65
Tilt: 10°
Measurement: SCI+SCE (specular component included+excluded)
UV: 100%
Focal length: 4 mm
Calibration: black body and white body

The measured values are set out in Table 3 below:

TABLE 3

| | | a* | b* | | | Melting |
|---|---|---|---|---|---|---|
| | | green- | yellow- | Density | HV after | point |
| Example° | L* | red | blue | [g/cm₃] | annealing | [° C.] |
| 1 (comp.) | 88.5 | 0.2 | 4.1 | 20.7 | 140 | 1850 |
| 2 (comp.) | 89.5 | 0.60 | 2.8 | 15.7 | 150 | 1900 |
| 3 (comp.) | 90.4 | 0.93 | 2.0 | 12.4 | 100 | 1963 |
| 4 (inv.) | 89.2 | 0.75 | 2.6 | 12.2 | 160 | 1750 |
| 5 (inv.) | 88.7 | 0.79 | 2.9 | 12.1 | 180 | 1735 |

The Table 3 results show that the alloys according to the invention (examples 4 and 5) have colorimetric values very close to pure rhodium (example 3) while offering much lower density and melting points than the alloys of comparative examples 1 and 2, and therefore suitable for jewellery applications. The alloys according to the invention comply with the hardness after annealing criteria and exhibit sufficient scratch resistance.

1. A palladium-based alloy comprising, expressed in weight, between 50 and 55% of palladium, between 45% and 50% of rhodium; a quantity x of silver where 0%≦x≦5%, and a quantity R of a balance comprising at least one element selected from among iridium, ruthenium, platinum, titanium, zirconium and rhenium and combinations thereof, where 0%≦R≦5%.

2. The alloy according to claim 1, wherein x is lower than or equal to 2%.

3. The alloy according to claim 1, comprising, expressed in weight, between 50 and 53% of palladium, between 47% and 50% of rhodium; a quantity x of silver where 0%≦x≦2%, and a quantity R of a balance comprising at least one element selected from among iridium, ruthenium, platinum, titanium, zirconium and rhenium and combinations thereof, where 0%≦R≦3%.

4. The alloy according to claim 1, wherein x is equal to 0.

5. The alloy according to claim 1, wherein R is lower than or equal to 1%.

6. The alloy according to claim 5, wherein R is lower than or equal to 0.5%.

7. The alloy according to claim 6, wherein R is lower than or equal to 0.1%.

8. The alloy according to claim 1, wherein R is equal to 0.

9. The alloy according to claim 1, wherein x and R are equal to 0.

10. A timepiece or piece of jewellery comprising at least one component made of an alloy according to claim 1.
